(19) United States
(12) Patent Application Publication
(10) Pub. No.: US 2007/0044820 A1
(43) Pub. Date: Mar. 1, 2007

(54) Automatically configurable chemical dispensing system for cleaning equipment

(75) Inventors: Wai Yin Cedric Chan, Santa Cruz, CA (US); Andrew John Cocking, Ben Lomond, CA (US); James Wesley Livingston, Manton, CA (US); William Edward Simpson, New Berlin, WI (US); Douglas Thomas Story, Racine, WI (US)

Correspondence Address: QUARLES & BRADY LLP, 411 E. WISCONSIN AVENUE, SUITE 2040, MILWAUKEE, WI, 53202-4497, US

(73) Assignee: JohnsonDiversey, Inc.

(21) Appl. No.: 11/444,870

(22) Filed: Jun. 1, 2006

Related U.S. Application Data
(60) Provisional application No. 60/712,315, filed on Aug. 30, 2005.

(51) Int. Cl. B08B 7/04; B08B 3/00

(52) U.S. Cl. 134/18; 134/56 R

(57) ABSTRACT

A system controls dispensing different chemicals received from containers at a plurality of ports. Each container has data thereon that identifies the chemical within the container. The system reads the data from each container to determine which port is associated with each chemical. When a given chemical is required, the system activates a flow control device coupled to the port associated with that given chemical, thereby supplying the given chemical to a consuming device. Therefore regardless of into which port an operator places a particular chemical, the system automatically knows which port has which chemical and the dispensing is configured accordingly. Various mechanisms for storing the data on and reading the data from the container are described.

### CROSS-REFERENCE TO RELATED APPLICATIONS

This application claims benefit of U.S. Provisional Patent Application No. 60/712,315 filed on Aug. 30, 2005.

### STATEMENT REGARDING FEDERALLY SPONSORED RESEARCH OR DEVELOPMENT

Not Applicable

### BACKGROUND OF THE INVENTION

1. Field of the Invention

The present invention relates to cleaning apparatus, such as machines for washing kitchenware or laundry; and in particular to systems for automatically dispensing chemicals used by such cleaning apparatus.

2. Description of the Related Art

Commercial kitchens have equipment to clean and sanitize glassware, dishes, silverware, pot, pans and cooking utensils, which are collectively referred to as “kitchenware.” Such equipment, commonly known as a “dishwasher” or more generically as a “warewasher”, has a cabinet defining an internal chamber into which trays of kitchenware are placed for washing. A washing and rinsing assembly within the chamber has a plurality of nozzles from which water sprays onto the kitchenware being cleansed. The lower part of the cabinet forms a reservoir that collects the water which is repeatedly circulated through the nozzles by a pump during the wash cycle. In a dump and fill system, the reservoir is drained after the wash cycle and refilled with fresh water for rinsing which then is pumped through the nozzles.

At various times during the cleaning process, different chemicals are dispensed from supply containers into the warewasher. These chemicals may include a detergent, a rinse additive, and a sanitizer. Conventional warewashing equipment have separate receptacles for receiving these chemicals with each receptacle dedicated to only one type of chemical. For example, U.S. Pat. No. 6,322,242 discloses a dispensing system that has separate caps for chemical containers with supply lines running from each cap to the apparatus in which the chemicals will be used. Each cap and supply line is color coded to designate the type of chemical that is dispensed there through. Other types of marking have been used to indicate to employees which chemical container connects to each receptacle.

Chemicals for use in automatic warewashing machines are available from many manufacturers. The same type of chemical, detergent for example, may vary in concentration depending upon the specific manufacturer and even the same manufacturer may produce the same chemical in different concentrations. A lesser amount of a more concentrated chemical is required during each operating cycle than a lesser concentrated version of the same chemical. Therefore the amount of a chemical to dispense into the warewasher can vary depending upon the particular brand of the chemical.

Even with such location designations, employees still place the incorrect chemical in a particular dispenser location. This results in the wrong the chemical being dispensed at a particular time during the cleaning process. For example, a rinse additive might be dispensed in place of a detergent and thus the kitchenware is not properly cleaned.

Therefore, there still exists a need for a control system that eliminates the possibility of dispensing an incorrect chemical into a cleaning apparatus.

### SUMMARY OF THE INVENTION

An apparatus is provided to dispense a plurality of chemicals into a cleaning machine. The chemicals are supplied in a plurality of containers each having data recorded thereon. The apparatus includes a plurality of dispenser ports for receiving chemicals from the containers and a plurality of flow control devices that govern the flow of chemicals from each dispenser port to the cleaning machine. A data reader arrangement obtains the data on the containers from which chemicals are received at each of the plurality of dispenser ports.

A controller is connected to the plurality of flow control devices and to the data reader arrangement. The controller employs the data obtained from the containers to identify which of the plurality of ports received which of the plurality of chemicals. In response to a command to dispense a given chemical, the controller activates the respective flow control device which is associated with the dispenser port that received the given chemical. Thus a particular chemical can be received at any of the plurality of dispenser ports with the apparatus automatically knowing which port received which chemical.

Various mechanisms can be used to record the data on the containers. In one case, the data are recorded as indicia on a label and the data reader arrangement optically senses the indicia. For example, the indicia may be a barcode that is read by a conventional barcode scanner. In another case, the data are recorded in a radio frequency tag on the container and the data reader arrangement interrogates the radio frequency tag to obtain the data.

### BRIEF DESCRIPTION OF THE DRAWINGS

FIG. 1 is an isometric illustration of a commercial warewasher which incorporates the present invention;

FIG. 2 is a partial sectional drawing showing connection of a chemical container to the dispenser of the warewasher;

FIG. 3 is a schematic depiction of an optical system for reading indicia located on a chemical container;

FIG. 4 illustrates a system for reading a barcode located on the chemical container;

FIG. 5 is a schematic depiction of system for interrogating a radio frequency identification tag located on the chemical container;

FIG. 6 is a schematically shows the warewasher control circuit; and

FIG. 7 is a flowchart of a software routine that is executed by the control circuit to configure the warewasher operation to properly dispense each chemical.

### DETAILED DESCRIPTION OF THE INVENTION

The present inventive dispensing system will be described in the context of a warewasher for cleaning kitchenware, however it should be appreciated that this dispensing system can be utilized with other types of cleaning equipment, such as apparatus for washing laundry, cleaning floors, and cleaning vehicles to name but a few examples.

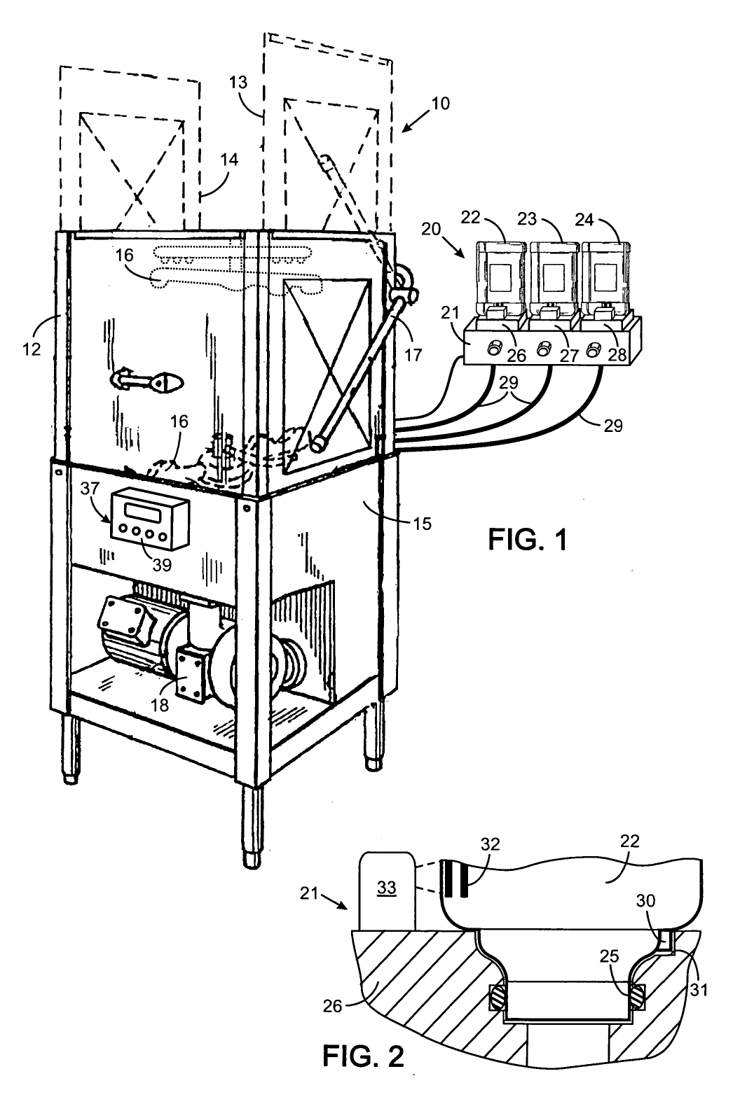

With initial reference to FIG. 1, a commercial kitchen warewasher 10 has a cabinet 12 defining a chamber into which kitchenware is placed for washing. Two side doors 13 and 14 are slidably mounted on the cabinet 12 to close openings through which racks of glasses, dishes, utensils, pot and pans pass into and out of the chamber. The side doors 13 and 14 are connected to a link arm 17 so that they operate in unison. The cabinet 12 contains standard washing and rinsing assembly that includes a plurality of nozzles 16 which spray water supplied by a pump 18. A region at the bottom of the cabinet 12 forms a reservoir 15 into which the water drains from the kitchenware and which holds a volume of water.

A dispensing system 20 is connected to the warewasher 10 to mete out different chemicals into the cabinet 12 at specific times during the cleaning process. The dispensing system 20 has a dispenser 21 that holds three containers 22, 23 and 24 that store a detergent, a rinse additive, and a sanitizer, for example. A different electrically operated pump is provided to feed each chemical from the respective container 22, 23 or 24 through supply tubes 29 to the warewasher cabinet 12. Each container 22, 23 and 24 is inverted so that its neck 25 fits into a separate port 26, 27 and 28 of the dispenser 21 as shown in FIG. 2 with respect to the first port 26 and first container 22. Each container has a key 30 that fits into a keyway 31 of the respective dispenser port, thereby orienting the container so that an indicia 32 on the label faces a data reader 33. It should be understood that the dispensing system 20 can utilize other forms of ports, such as for example the container caps with tubes shown in U.S. Pat. No. 6,322,242 or a reservoir that holds the chemical received from a container.

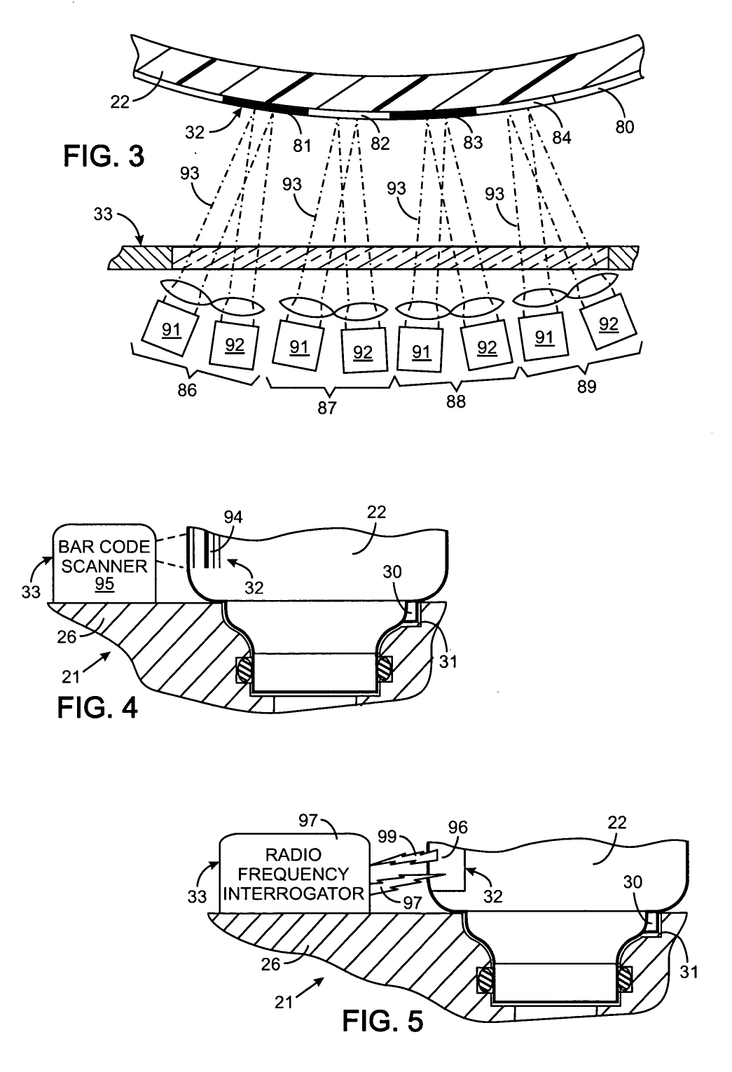

A separate data reader 33, 34 and 35 is provided for each port 26, 27 and 28, respectively to read data from the associated container and collectively form a data reader arrangement. The three data readers 33-35 are identical and an exemplary type of data reader is shown in FIG. 3 as the first data reader 33. In this case, the first container 22 has a label 80 with four areas 81, 82, 83 and 84 thereon, which may either be reflective or non-reflective to light. For example, each area may be printed with either white or black ink to define its reflectivity. The reflectivity of each of the four areas 81-84 is used to encode data regarding the particular container 22, and specifically to identify the type of chemical contained therein. With four label areas 81-84, sixteen different types of chemicals can be identified. Therefore, the indicia formed by the four label areas 81-84 can indicate not only the three chemical types (detergent, rinsing agent, or sanitizer), but other characteristic of the general chemical type, such as its concentration.

The data reader 33 has four separate pairs 86, 87, 88 and 89 of light emitters 91 and detectors 92. Each emitter-detector pair 86-89 is focused on a different one of the label areas 81-84, respectively, to produce a signal that indicates the degree of reflectivity of the associated label, e.g. whether the area is white or black. For example, in the first emitter-detector pair 86, the light emitter 91 transmits a beam 93 of light which is directed toward label area 84 on the container 22. Depending on the reflectivity of the label area, the beam may be reflected back to the associated detector 92. Even a black label area may reflect some light back to the associated detector. The emitter-detector pair may operate at a narrow band of wavelengths (for example in the infrared spectrum) to distinguish the sensing light from ambient light. The intensity of the reflected light is a function of the reflectivity of the associated label area 81. Specifically, a white label area will reflect a greater amount of light than a black label area, thereby producing analog electrical signals of different magnitudes from the detector 92. Therefore by comparing the signals from each light detector 92 to a threshold level, each analog signal is converted into a digital bit that indicates whether the associated label area is white or black. The four digital bits from the plurality of light detectors 92 of the data reader 33 designate the data about the chemical that is encoded by the indicia 32, e.g. one of the sixteen chemical types. Because a black label area reflects some light, the failure of the detectors 92 to sense any reflected light indicates the absence of a container at that particular dispenser port.

Where a need to encode a greater number of chemical types is required, other kinds of data recording mechanisms may be utilized. For example as shown in FIG. 4, a conventional barcode 94 can be utilized as the indicia 32 on container 22. The barcode 94 can encode not only the type of chemical, but other information such as its manufacture date and concentration. In this embodiment, a standard barcode scanner 95 is employed as the first data reader 33.

There is a trend toward providing radio frequency identification tags on products, thereby enabling the products to be tracked during distribution from manufacturer to the ultimate consumer. Conventional radio frequency tags act as a transponder and respond to being interrogated by a radio frequency (RF) signal by producing a reply signal that carries information identifying the particular piece of merchandise. Such radio frequency identification tags can be utilized on the chemical containers 22-24 as the indicia 32 to identify the particular type of chemical contained therein, the concentration of that chemical, and other product information. As shown in FIG. 5, a radio frequency tag 96 is attached to the first container 22. In this embodiment, the first data reader 33 comprises a conventional RF interrogator 97 that emits a radio frequency signal 98 that is directed toward the container 22. In order to avoid cross-talk between the three data readers 33-35, the transmitted radio frequency signal has a relatively low power so that it does not activate a tag on an adjacent container 23 or 24 within the dispensing system 20. This ensures that the data being read will come from a container within the first dispenser port 26. Upon receiving a signal at the proper frequency from RF interrogator 97, the identification tag 96 returns a reply signal 99 that carries encoded information about the chemical within the first container 22 which the manufacturer stored in the tag. The radio frequency interrogator 97 receives and decodes that reply signal 99 to extract the encoded data.

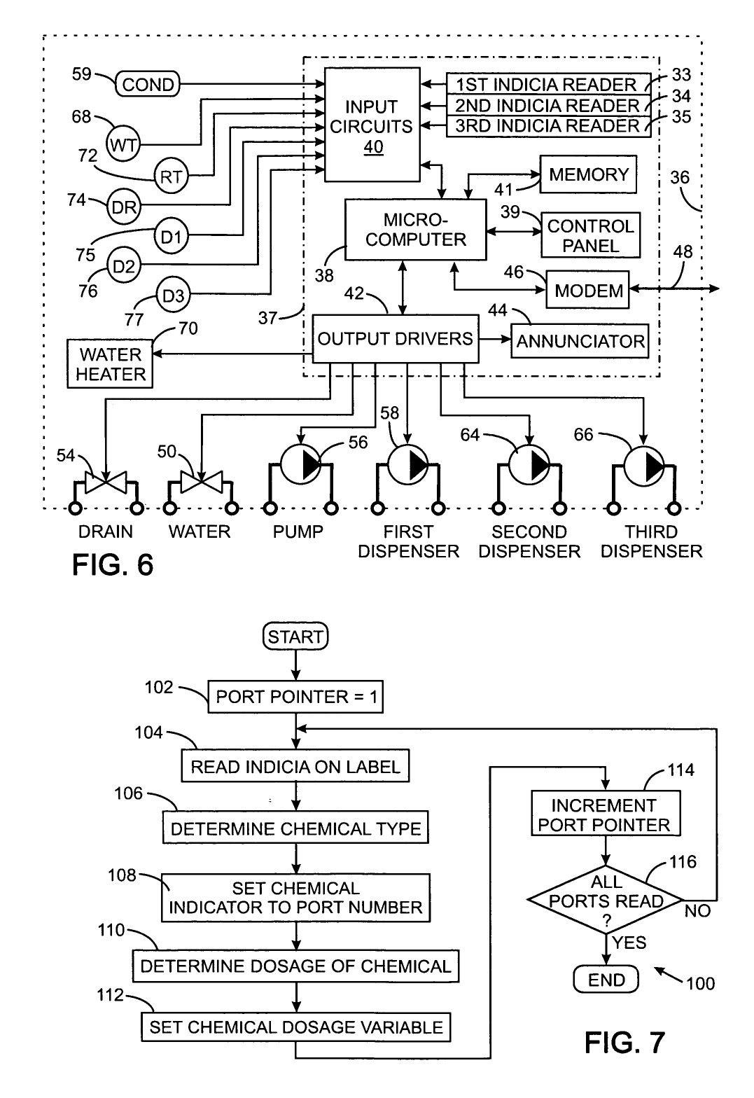

Referring to FIG. 6, the three data readers 33-35 are part of a control system 36 the governs the operation of the warewasher 10. The control system 36 employs an electronic controller 37 that is based on a microcomputer 38 which executes a software control program stored in a memory 41. The controller 37 includes input circuits 40 that receive signals from the data readers 33-35. Input signals also are received from the operator control panel 39 that has switches by which the human operator starts a cleaning operation and selects operational functions to be performed. The control panel 39 also has devices that provide visual indications of the functional status of the warewasher. A modem 46 is connected to the microcomputer 38 for the exchange of data with other control systems and computers via a computer network 48.

The controller 37 has several output drivers 42, one of which activates an annunciator 44, such as a buzzer or a lamp which produce an audible or visible warning. Another output driver 42 operates a solenoid water valve 50 during the rinse cycle to send fresh water through the nozzles 16. A manually operated supply valve 52 is provided to fill the reservoir 15 at the bottom of the cabinet 12 prior to operating the warewasher 10. A drain valve 54 is electrically operated to empty the reservoir 15. Another output of the controller 37 activates the pump 56 during the wash cycle. The controller 37 also automatically governs dispensing detergent and additives into the warewasher cabinet 12. Specifically, the microcomputer 38 determines when to activate a detergent pump 58 in response to a signal from a conductivity sensor 59, that is located below the water line of the reservoir 15. Other output drivers 42 operate pumps 64 and 66 to introduce the rinse additive and the sanitizer chemicals into the warewasher cabinet 12 at appropriate times during the cleaning cycle. Alternatively the chemicals can flow to the warewasher cabinet by gravity in which case the dispenser pumps 58, 64 and 66 can be replaced by electrically operated valves to control that flow. Such dispenser pumps and valves are generically referred to as “flow control devices.”

Several different types of sensors can be connected to the input circuits 40 of the controller 37. A water temperature (WT) sensor 68 is located in the reservoir 15 to produce a signal indicating the temperature of the water. The controller 37 responds to that temperature signal by activating a water heater 70 that has a heating element within the reservoir. Another temperature sensor 72 is mounted in a conduit that carries water during the rinse cycle and thus provides an indication of the rinse water temperature (RT) to ensure that the proper water temperature is being maintained. If the rinse water is not at the proper temperature the controller 37 adds the sanitizer chemical from the dispensing system 20. A pair of sensor switches (DR) 74 provide signals indicating when either side door 14 is open and the controller 37 suspends operation in those cases. A set of three sensors 75, 76 and 77 respectively detect when the chemical containers 22, 23 and 24 are empty.

The present invention relates to a mechanism which dispenses chemicals from the dispenser 21 based on the information read from the data recorded on the containers 22-24 placed into the dispenser. Occasionally, the microcomputer 38 reads the data signals from the three data readers 33-35 to determine characteristics of the chemical at each dispenser port 26-28. In the preferred embodiment, the data readers are polled each time a washing operation commences. However, in other cases, the signals from the data readers may be inspected by the microcomputer 38 whenever the operator changes a chemical container and presses a button on the dispenser 21 to indicate that event. In a system in which each dispenser port 26-28 has a reservoir that holds the chemical received from a container, the data reader scans the indicia when an operator fills the reservoir from the container.

When it is desired to read the signals from the three data readers 33, 34 and 35, the microcomputer 38 executes a software routine 100 depicted in FIG. 7. That routine commences at step 102 by setting a variable, designated a Port Pointer, to one to indicate the first port 26 of the dispenser 21. Then, at step 104, the microcomputer reads the signal from the data reader for the indicated port, at this time the first data reader 33. The signal from that data reader is decoded at step 106 to extract the information indicating the type of chemical, e.g. detergent, rinsing agent or sanitizer, within the associated container. At step 108, that chemical type designation is stored within a table in the memory 41 to provide an indication of the chemical available at the first dispenser port 26.

Next at step 110, the microcomputer 38 determines the appropriate dose of this chemical to dispense during each operation of the warewasher. In one version of the present invention, the microcomputer 38 utilizes the indication of the particular type of chemical to address a look-up table within the memory 41 that contains a dose value for each commonly used type of chemical. For example, various types of detergent may require that different amounts be dispensed during each wash cycle of the warewasher 10. Even the same general type of detergent may come in different concentrations, which also require that different amounts be dispensed for optimum cleaning and economy. The dose value preferably is defined by a particular amount of time that the pump 58 for the first dispenser port 26 should be operated in order to dispense the proper amount of chemical. Alternatively, for dispensing systems 20 that utilize a radio frequency identification tag 96 on the container, the information obtained from that tag may indicate not only the type of chemical, but also its physio-chemical parameters, such as viscosity, density, and concentration. The concentration is used to address in a look-up table to determine the pump operating time. In other situations, the control system 36 may be configured with the proper dispenser pump operating interval for a detergent, rinsing agent or sanitizer that has a predefined concentration. When the same general type of chemical is found with a different concentration, the microcomputer 38 executes a preprogrammed equation to derive the proper pump operating time for that different concentration, based on the pump operating time for the predefined concentration. In either situation, the appropriate pump operating time for the particular chemical in the container inserted in the first port 26 is then stored at step 112 as a the value of a dose variable for that port. This completes the configuration of the first port 26 with the type of chemical and the chemical dose.

The software routine 100 then advances to step 114 at which the Port Pointer is incremented to read and process the indicia for the container in the next port. At step 116, the program then returns to step 104 to process that data. When all three ports 26-28 have been configured in this manner, the software routine 100 terminates and normal washing operation of the warewasher 10 commences. At that time the memory 41 contains a designation of which port 26-28 contains each type of chemical (detergent, rinsing agent and sanitizer) and the pump operating time for that port.

When the controller 37 gets to a point during the cleaning cycle at which detergent is to be dispensed into the cabinet 12, the microcomputer 38 accesses the table within memory 41 that specifies the type of chemical inserted into each port 26, 27 and 28 of the dispenser 21. Specifically, the microcomputer accesses a memory location that indicates the port into which a container of detergent has been inserted. That port designation determines which dispenser pumps 58, 64 or 66 to activate for the detergent. The table in memory 41 also specifies the amount of time that this pump should be operated to feed the proper dose of the detergent into the warewasher cabinet 12. The microcomputer 38 then activates the respective dispenser pump for that prescribed period of time. A similar operation is conducted at the appropriate times during the cleaning cycle to dispense the rinsing agent and the sanitizer from the dispensing system 20. Alternatively variable speed dispenser pumps 58, 64 or 66 could be employed and the dose of each chemical is controlled by varying the pump speed and thus the rate at which the chemical is supplied to the warewasher.

Therefore, the present system properly dispenses the different chemicals regardless of into which port 26, 27 or 28 the operator has inserted a container of a particular chemical. In other words, unlike previous systems in which a particular port was designated to always receive a container of a given chemical, detergent for example, a particular chemical may be placed into any port and the operation of the machine is automatically reconfigured to properly dispense that chemical. The present dispensing system also detects when the same chemical is placed into more than one dispenser ports 26-28, in which case the operator is alerted to that occurrence.

Furthermore, if the signals from a data readers 33-35 indicate the absence of a particular chemical that is critical to proper cleaning, an alarm annunciation is issued. In addition, operation of the warewasher may be suspended by the controller 37 until a container of that chemical is inserted into the dispensing system 20. It should be understood that not all of the different chemicals are essential to cleaning in all circumstances. A sanitizer typically only is required if the rinse water is below a defined temperature, e.g. 74° C., as water above that temperature will sanitize the kitchenware without requiring chemical augmentation. Therefore, operation of the warewasher 10 may continue after the supply of sanitizer is exhausted, as long as the rinse water is above the defined temperature.

The foregoing description was primarily directed to a preferred embodiment of the invention. Although some attention was given to various alternatives within the scope of the invention, it is anticipated that one skilled in the art will likely realize additional alternatives that are now apparent from disclosure of embodiments of the invention. Accordingly, the scope of the invention should be determined from the following claims and not limited by the above disclosure.

What is claimed is:

1. An apparatus for dispensing a plurality of chemicals into a cleaning machine, wherein the chemicals are held in a plurality of containers each having data recorded thereon, said apparatus comprising:
a plurality of dispenser ports for receiving the chemicals from the containers;
a plurality of flow control devices each associated with a different one of the plurality of dispenser ports to control flow of a chemical therefrom to the cleaning machine;
a data reader arrangement that reads the data on the containers from which chemicals are received at each of the plurality of dispenser ports; and
a controller connected to the plurality of flow control devices and the data reader arrangement, wherein the controller responds to a command to dispense a given type of chemical by determining in response to the data reader arrangement a given one of the plurality of dispenser ports that has received that type of chemical, and then by activating one of the plurality of flow control devices associated with that given one of the plurality of dispenser ports.

2. The apparatus as recited in claim 1 wherein each of the plurality of flow control devices is selected from a group consisting of a pump and a valve.

3. The apparatus as recited in claim 1 wherein the data reader arrangement optically reads indicia on each container.

4. The apparatus as recited in claim 3 wherein the indicia on each container are formed by a plurality of areas; and the data reader arrangement senses an optical characteristic of each of the plurality of areas.

5. The apparatus as recited in claim 4 wherein the data reader arrangement comprises a separate data reader for each dispenser port.

6. The apparatus as recited in claim 5 wherein each separate data reader comprises a plurality of light detectors each sensing the optical characteristic of a different one of the plurality of areas.

7. The apparatus as recited in claim 1 wherein the data reader arrangement comprises at least one barcode reader.

8. The apparatus as recited in claim 1 wherein the data are encoded in a radio frequency tag on each container; and the data reader arrangement comprises a device that interrogates the radio frequency tag to obtain the data.

9. The apparatus as recited in claim 1 wherein the data reader arrangement comprises a plurality of data readers each associated with a different one of the plurality of dispenser ports.

10. A method for dispensing a plurality of types of chemicals into a cleaning machine, wherein each chemical is held in a container that has data recorded thereon, said apparatus comprising:
receiving each of the plurality of types of chemicals at a separate one of a plurality of dispenser ports;
reading the data from a container for each of the plurality of types of chemicals;
receiving a command to dispense a given type of chemical;
in response to reading the data from a container, determining a given one of the plurality of dispenser ports that has received the given type of chemical; and
in response to receiving the command, activating a flow control device associated with that given one of the plurality of dispenser ports.

11. The method as recited in claim 10 further comprising:
in response to reading the data from a container, determining a dose amount for the given type of chemical; and
wherein activating a flow control device comprises operating the flow control device in response to the dose amount.

12. The method as recited in claim 10 wherein the data are recorded as indicia on the container and reading the data optically senses the indicia.

13. The method as recited in claim 12 wherein reading the data comprises scanning a barcode.

14. The method as recited in claim 10 wherein reading the data comprises interrogating a radio frequency tag on the container to obtain the data.

15. An apparatus for dispensing a plurality of types of chemicals into a cleaning machine, wherein the chemicals are held in a plurality of containers each having data recorded thereon, said apparatus comprising:
a plurality of dispenser ports for receiving chemicals from the containers;
a data reader arrangement that reads data on the containers from which chemicals are received at each of the plurality of dispenser ports; and
a controller connected to the data reader arrangement, and responding to a command to dispense a given type of chemical by selecting one of the plurality of dispenser ports based on data read by the data reader arrangement.

16. The apparatus as recited in claim 15:
further comprising a plurality of flow control devices each associated with a different one of the plurality of dispenser ports to control flow of a chemical therefrom to the cleaning machine; and
wherein selecting one of the plurality of dispenser port comprises activating one of the plurality of flow control devices.

17. The apparatus as recited in claim 15 wherein the data reader arrangement optically reads indicia on each container.

18. The apparatus as recited in claim 17 wherein the indicia on each container are formed by a plurality of areas; and the data reader arrangement senses an optical characteristic of each of the plurality of areas.

19. The apparatus as recited in claim 18 wherein the data reader arrangement comprises a separate data reader for each dispenser port.

20. The apparatus as recited in claim 19 wherein each separate data reader comprises a plurality of light detectors each sensing the optical characteristic of a different one of the plurality of areas.

21. The apparatus as recited in claim 15 wherein the data reader arrangement comprises at least one barcode reader.

22. The apparatus as recited in claim 15 wherein the data are encoded in a radio frequency tag on each container; and the data reader arrangement comprises a device that interrogates the radio frequency tag to obtain the data.

23. The apparatus as recited in claim 15 wherein the data reader arrangement comprises a plurality of data readers each associated with a different one of the plurality of dispenser ports.
